(19) United States
(12) Patent Application Publication
(10) Pub. No.: US 2014/0008058 A1
(43) Pub. Date: Jan. 9, 2014

(54) METHODS FOR INCREASING METHANOGENESIS IN SUBSURFACE RESERVOIRS

(71) Applicants: Ian McCutcheon Head, Prudhoe (GB); Johnny Mark Cordiner, Edinburgh (GB)

(72) Inventors: Ian McCutcheon Head, Prudhoe (GB); Johnny Mark Cordiner, Edinburgh (GB)

(73) Assignee: PROFERO ENERGY INC.

(21) Appl. No.: 13/543,679

(22) Filed: Jul. 6, 2012

(51) Int. Cl. C09K 8/60; E21B 43/16

(52) U.S. Cl. CPC C09K 8/60; E21B 43/16
USPC 166/246

(57) ABSTRACT

Methods for increasing the increasing the rate of methane production in a subsurface reservoir are provided.

### BACKGROUND OF THE INVENTION

Subsurface oil reservoirs are promising and important sources for the generation and collection of increasing amounts of hydrocarbons as an energy source. In particular, since at best about 40% of oil is recoverable from oil reservoirs, methods for the recovery of the remaining oil in the reservoirs either as oil or as methane are of great interest. Microbes are responsible for biodegrading conventional crude oil to intermediates that are converted by other microbes (methanogens) into methane leaving behind heavy oil, which can be then further biodegraded. The processes of heavy oil formation and methane gas generation (methanogenesis) occur over geological time scales of millions of years. Microbial conversion of oil to methane involves a variety of multi-step pathways and a consortium of microorganisms working together in concert. Pathways include fermentation of oil to acetate, CO₂ and hydrogen, as well as microbial oxidation of acetate to CO₂ and hydrogen and subsequent microbial reduction of CO₂ to methane with hydrogen. Other pathways include direct fermentation of acetate to methane Each of these biochemical transformations are carried out by specific types of microbes and often take place in the face of competing reactions such as conversion of methane and the acetate and hydrogen intermediates to other products such as H₂S, H₂O, and CO₂.

It has been recognized that the naturally slow methanogenic biodegradation process can be accelerated to enhance methane production in the reservoir. For example, as described in WO 2005/115649 entitled “Process for Stimulating Production of Methane from Petroleum in Subterranean Formations”, techniques are described for injecting one or more agents into a reservoir in which methanogenic microbial consortia are present to modify the reservoir environment to promote in situ microbial degradation of petroleum, promote microbial generation of methane, and to demote in situ microbial degradation of methane.

While that reference describes generic procedures for enhanced methane production, there is still a need for improved methods for stimulating methane production to maximize the potential of subsurface oil reservoirs as sources of hydrocarbons. Adding the proper amounts and types of agents and nutrients to optimally stimulate methane production from the particular petroleum components found in an oil reservoir remains a considerable challenge in view of the variety of microbes and pathways involved, including microbes that may be present in the reservoir but that do not participate or are deleterious to methane production. For example, stimulation and the growth of non-methanogens may out-compete methanogens for common intermediates essential to methane production or drive microbial transformations to products (e.g. CO₂, H₂S, etc.) other than methane.

### BRIEF SUMMARY OF THE INVENTION

This invention is based, in part, on the discovery that significant enhancement in methane generation from oil reservoirs can be achieved. In one aspect, very high concentrations of nutrients shown to be effective for microbial conversion of oil to methane are added as a bolus into the reservoir thereby enhancing the total amount of nutrients available to the microbes in a manner such that methane generation is maximized while at the same time ensuring that the concentration of nutrients in the reservoir is non-lethal to the microbes.

In a preferred embodiment, the methane production levels in the reservoir are increased significantly such that methane production in the reservoir is exponentially increased over endogenous rates. Under optimal conditions, methane production can be increased to a level of at least 25 MCF and preferably at least 50 MCF per day.

In view of the above, in one of its embodiments, this invention is directed to a method for enhancing methanogenesis in an oil reservoir comprising methanogenic microbial consortia and foundation water which method comprises adding a solution comprising methanogenic nutrients which comprise at least nitrogen and phosphate ions

wherein the amount of said nutrients in the solution is sufficient to enhance the rate of methanogenesis in said reservoir at its final dilution without being lethal to said methanogenic microbial consortia, and

further wherein the added concentration of said nutrients in said solution facilitates dispersion of the nutrients from the said solution into the foundation water.

The solution of nutrients is preferably an aqueous solution and can occur in a single injection or in an iterative process where the aqueous solution is divided into several injections wherein each injection contains a known concentration of nutrients. In one preferred embodiment, after each injection, the concentration of nutrients in the foundation water is determined and adjustments are made to each additional injection to achieve the desired concentration of nutrients in the foundation water.

In a preferred embodiment, the amount of water used to inject the nutrients is minimized such that the injected water does not significantly alter the composition of the foundation water but for the nutrients added. That is to say that the salinity of the foundation water will not vary by more than 1% and preferably not more than 0.1% after injection as compared to prior to injection except for changes in concentration of the nutrients added. Examples of characteristics which are not significantly altered include salinity, pH, temperature, non-nutrient ion concentrations, etc.

When higher concentrations of nutrients in the water are injected, the volume of reservoir penetration by nutrient at concentration levels sufficient to provoke the desired rate methanogenesis acceleration is increased. As a corollary, nutrient concentration diminishes the further from the point of nutrient injection which, in turn, lowers the amount of nutrient available to the methanogenic consortia.

This invention is predicated in part on the discovery that increasing concentrations to levels previously believed to be deleterious to methanogenesis actually is beneficial as it increases the distance penetration by the injection water/nutrient mix before the quantity of nutrient available is too low to provoke the desired rate of methanogenesis acceleration. As a consequence the quantity of methane produced from an injection point is increased. This, of course, is an important benefit for provoking sufficient hydrocarbon production to make the process commercially viable. In one embodiment, the concentration of ammonium ions (NH₄⁺) added is up to the saturation concentration and the concentration of phosphate ions (H₂PO₄⁻) added is up to the saturation concentration. One could also use less than the saturated concentration at one or more well heads. The concentration of ammonium and phosphate ions is selected so as to achieve the ideal concentration to provoke the desired rate of methanogenesis acceleration.

In one preferred embodiment, the concentration of ammonium ions added to the reservoir is sufficient that at least a portion of the foundation water has a concentration of ammonium ions of about 5.4 g/L (typically ammonium chloride) and a concentration of phosphate ions (H₂PO₄) of about 1.376 g/L (typically a potassium or sodium salt).

Surprisingly, it has been shown that the methanogens are hardy microbes and tolerate concentrations of nutrients heretofore thought to be toxic. This finding allows for a significant increase in the amount of nutrients which can be added to the reservoir.

The term “saturation concentration” refers to either the concentration of the nutrient itself or as a complex with a sequestering agent as is well known in the art.

In evaluating the increase in methanogenesis, one can maintain the reservoir under conditions wherein methane concentration produced at the well head can be measured. Preferably, the amount of methane produced is at least 0.7 MCF per day. If the pressure increase is insufficient, additional nutrients can be added as necessary. Alternatively, the reservoir can remain closed and the methane produced can increase the pressure in the reservoir in either a localized or a reservoir wide manner.

In another embodiment, there is provided a method for increasing the rate of methanogenesis in a petroleum reservoir comprising methanogenic microbial consortia and foundation water which method comprises:

a) injecting through a well head a solution of stimulants comprising ammonium and phosphate ions to the reservoir in an amount such that their concentration in the reservoir is above the critical concentration to effect enhanced methanogenesis but below a lethal dosing to the methanogenic microbial consortia; and

b) maintaining said reservoir under conditions such that the rate of methanogenesis is increased,

wherein the concentration of the ammonium ions injected into the reservoir is up to about saturation concentration and the concentration of phosphate ions injected into the reservoir is up to about saturation concentration.

In another embodiment, there is provided a method for increasing the rate of methanogenesis in a petroleum reservoir comprising methanogenic microbial consortia and foundation water which method comprises:

a) injecting through a well head a solution of stimulants comprising ammonium and phosphate ions to the reservoir in an amount such that their concentration in the reservoir is above the critical concentration to effect enhanced methanogenesis but below a lethal dosing to the methanogenic microbial consortia; and

b) maintaining said reservoir under conditions such that the rate of methanogenesis is increased,

wherein the concentration of the ammonium ions injected into the reservoir is from about 1 g/L to its saturation concentration and the concentration of phosphate ions injected into the reservoir is from about 0.4 g/L to its saturation concentration.

Preferably, the amount of nutrient enriched solution added to the reservoir is such that the salinity of the reservoir does not change by more than 1% and more preferably by no more than 0.1% once equilibrium is established. In another preferred embodiment, the temperature of the nutrient enriched solution is maintained at approximately the temperature of the foundation water in the reservoir to which it is being added. In yet another preferred embodiment, the amount of nutrient added is from about 1 g/L to its saturation concentration or about 3 g/L to its saturation concentration of ammonium ions and from about 0.4 g/L to its saturation concentration or about 1.5 g/L to its saturation concentration of phosphate ions. In one preferred embodiment, the concentration of nutrients added provides for a maximal zone (volume) in the foundation water of an ammonium ion concentration of about 5.400 g/L of a phosphate ion concentration of about 1.376 g/L. Such can be done by a single addition or multiple additions at single or multiple well heads.

In one embodiment, the temperature of the solution of stimulants is maintained at approximately the temperature of the foundation water in the reservoir to which it is being added.

Preferably, the solution is an aqueous solution.

In an optional embodiment, a second solution can be injected into the reservoir through the well head to enhance methanogenesis. Such a second solution comprises an inhibitor or a mixture of inhibitors wherein the amount of the inhibitors in the second solution is sufficient to maintain a rate of methanogenesis in said reservoir in conjunction with the added nutrients and wherein the amount of inhibitors added to said reservoir water is non-lethal to said microbes.

In one embodiment, the inhibitors are included in an aqueous solution and, in another embodiment, the inhibitors are combined with the solution of stimulants. In another embodiment, the inhibitors are included in a separate aqueous solution from that of the stimulants.

### BRIEF DESCRIPTION OF THE DRAWINGS

FIG. 1 shows the various microbial mediated pathways that convert hydrocarbons to methane via an acetate intermediate. Also shown are pathways that degrade methane and acetate.

### DETAILED DESCRIPTION OF THE INVENTION

In this specification and in the claims that follow, reference will be made to a number of terms that shall be defined to have the following meanings unless specified otherwise:

### Definitions

As used in the specification and claims, the singular form “a”, “an” and “the” include plural references unless the context clearly dictates otherwise.

As used herein, the term “comprising” is intended to mean that the compositions and methods include the recited elements, but not excluding others.

As used herein, the term “about” when used in association with a measurement, or used to modify a value, a unit, a constant, or a range of values, refers to variations of +/−3%. It is to be understood, although not always explicitly stated that all numerical designations are preceded by the term “about”. Accordingly all numerical designations, e.g., pH, temperature, time, concentration, and molecular weight, including ranges, are approximations which are varied (+) or (−) by increments of 3%. It also is to be understood, although not always explicitly stated, that the reagents described herein are merely exemplary and that equivalents of such are known in the art.

The term “ppm” or “parts per million” as used herein refers to the mass ratio of solutes to water multiplied by one million. 1 ppm is equivalent to 1 mg/L.

The terms “methanogenic microorganisms” or “methanogenic microbes” refer to those microbes or combination of microbes that produce methane from oil in hydrocarbon reservoirs. Such microbes are anaerobic and, accordingly, exogenous oxygen is contra-indicated during any injection. Methanogenic microbes are well known in the art and include, by way of example only, Methanocalculus spp., Methanogenium spp., Methanoculleus spp., members of the Methanosarcinales (all methanogenic archea), and associated syntrophic organisms providing acetate and hydrogen for the methanogens these including Syntrophus spp., Smithella spp. Marinobacter spp., Syntrophobacter spp., Syntrophomonas spp. (all syntrophic bacterial partners that may convert hydrocarbons to substrates for methanogenic archaea) and the like.

The term “non-lethal” means that after addition of the stimulant solution and optionally the inhibitor solution, a viable population of methanogenic microbes remain in the foundation water. Even if some amount of methanogenic microbes may die, as long as there is a viable population of methanogenic microbes in the foundation water, the level of stimulant solution added is considered “non-lethal.”

The term “nutrient” or “methanogenic nutrient” (sometimes referred to herein as “stimulant”) refers to a component or mixture of components such as gases, inorganic or organic ions including anions, cations and combinations thereof (salts) which stimulate the activity and/or facilitate growth of one or more methanogenic microbes. To facilitate growth, the nutrients can supply one or more key nutritional components to one or more of the microbes comprising the consortium of methanogenic microbes.

The nutrient can be either an endogenous nutrient already present in the foundation water or an exogenous nutrient—one which is not present in the foundation water.

In one embodiment, the nutrient is an inorganic salt and more preferably is an inorganic salt selected from one or more of NH₄Cl, KH₂PO₄, FeSO₄.7H₂O, MnCl₂.4H₂O, CoCl₂.6H₂O, NiCl₂.6H₂O, CuCl₂.2H₂O, ZnSO₄.7H₂O, Na₂MoO₄. H₂O, Na₂SeO₃.5H₂O, Na₂WO₄.2H₂O, POx compounds were x is 2, 3 or 4, Na₃PO₄, K₃PO₄, KH₂PO₄, K₂HPO₄, NaH₂PO₄, Na₂HPO₄, H₃PO₄, H₃PO₃, H₃PO₂, C₁-C₂₀ alkyl phosphate compounds, (C₁-C₂₀)₃trialkyl phosphate such as triethyl phosphate), tripoly phosphates, condensed forms of phosphoric acid, including tripolyphosphoric acid, pyrophosphoric acid, salts of condensed phosphoric acids, e.g., potassium or sodium tripolyphosphate, and the like. Both hydrated and anhydrous forms may be used.

Components heretofore considered as nutrients have been found to deleterious to methanogenesis and in a preferred embodiment are excluded from the nutrient composition. Such components include sulfate, nitrate, nitrite, and oxygen.

The term “inhibitor” refers to a component or mixture of components such as inorganic or organic compounds including anions, cations and combinations thereof (salts) which inhibit one or more microbial reactions which either degrade methane and/or inhibit one or more reactions which divert the petroleum components in the reservoir into products other than methane (“competing reactions”). Such inhibitors can be components that interfere with one or more of these competing reactions or which are selectively toxic to non-methanogenic microbes. Preferably, such inhibitors are one or more components that interfere with such competing reactions. In a preferred embodiment, the inhibitor is an inorganic salt and more preferably is a molybdate salt such as sodium molybdate (Na₂MoO₄), and hydrates thereof which are inhibitors of sulfate reducers, and sodium chlorate (NaClO₃) for inhibiting nitrate reducers.

The inhibitor can be either an endogenous inhibitor—one which is already present in the foundation water or an exogenous inhibitor—one which is not present in the foundation water.

The term “non-nutrient” refers to components which are not nutrients or inhibitors. Such non-nutrients include sodium chloride and other salts which affect the salinity of the water in the reservoir. In general, the microbes are adapted to the salinity of the foundation water. The injection strategy seeks to maintain essentially the same gross salinity of the foundation water after injection as was present prior to injection.

The term “petroleum components suitable for methanogenesis” refers to liquid, gaseous or solid hydrocarbons (hydrocarbon only) or related petroleum non-hydrocarbons (those containing hydrogen and carbon plus one or more heteroatoms such as sulphur, nitrogen or oxygen) all of which are the major biodegradable components of oil. Preferred oils are those rich in n-alkanes in reservoirs in the carbon number range 3 to 30 where natural biodegradation is occurring. Typically, n-alkanes represent up to a maximum around 10 weight percent of the petroleum components and typically petroleum/oils suitable for methanogenesis will have from 1-5% n-alkanes present. Especially preferred oils will also contain an extended suite of homologous alkylbenzenes and alkyltoluenes. Oil viscosity can range from very low values (from 5 or 10 centipoise (cP) at 20° C.) to values as high as 7000 cP at reservoir conditions. Low values generally mean more reactive oils but higher values favor gas over oil production. While n-alkane rich oils are preferred the inventors have shown that in many reservoirs oils without n-alkanes or alkylbenzenes acceleration of natural methanogenesis is possible as the microorganisms have adapted to consumption of less desirable reactants.

The term “foundation water” refers to the water endogenously present in the reservoir and includes the cations, anions, soluble organics, and other components as well as its temperature, pH, salinity, etc.

The term “MCF” means one thousand (1,000) cubic feet.

The term “incremental increase in methane per day” refers to the increase in methane production when the reservoir has been treated under conditions to stimulate methanogenesis. In one embodiment, this can be measured by the rate of methanogenesis (e.g., as determined by the increase in pressure at a well head). In a preferred embodiment, this increase is at least 80% of the maximum rate of methane generated from the reservoir over a 60 day period and preferably over a 120 day period.

The term “well head” refers generically to any well head in the reservoir. Reference to a single well head is not intended herein limiting. Rather, injection of stimulants and/or inhibitors can be conducted at one or more well heads and hydrocarbon production measured at the same or different well heads in the reservoir.

### Methodology

This invention is predicated on the discovery that prior failed attempts to reach reasonable rates of methane production in a reservoir via enhancing in situ methanogenesis were based on the erroneous belief that very high concentrations of nutrients would be toxic to the methanogens. This invention is further predicated on the discovery that the injection of a very high concentration of nutrients allows for dispersion across a wider range of the foundation water thereby allowing contact of sufficient quantity of nutrient with a greater number of methanogens.

In one embodiment, the nutrients are added to the reservoir without prior assaying of the reservoir, as most reservoirs retain a viable population of methanogens.

In another embodiment, an analysis of the reservoir is conducted prior to addition of the nutrients. Such an analysis comprises:

a) evaluating petroleum components in the reservoir, methanogenic microbial consortia present, stimulants and/or inhibitors already present in the reservoir, pressure and temperature, and salinity of foundation water in the reservoir;

b) confirming the presence of at least one or more of the microbes that comprise a methanogenic consortium selected from the group consisting of members of the Methanomicrobiales (Methanocalculus spp., Methanogenium spp., Methanoculleus spp.), the Methanosarcinales and anaerobic hydrocarbon fermenting bacteria such as Syntrophus spp., Smithella spp., Syntrophobacter spp., Syntrophomonas spp., and Marinobacter spp.;

c) evaluating the nature and amount of stimulants to be added based on the evaluation in a) and b) above wherein the stimulants are selected from the group consisting of those that stimulate one or more members of the methanogenic microbial consortium set forth in b) and further wherein said stimulants are either endogenous and/or exogenous stimulants;

d) evaluating the nature and amount of optional inhibitors to be added based on the evaluation in a) and b) above wherein the inhibitors are selected from the group consisting of those that inhibit one or more non-methanogenic pathways and further wherein said inhibitors are either endogenous and/or exogenous inhibitors;

e) injecting a solution of stimulants comprising up to saturation concentration of ammonium ions and up to saturation concentration of phosphate ions into the reservoir through a well head such that after injection the total concentration in the reservoir of stimulants is above the critical concentration to effect enhanced methanogenesis but below a lethal dosing for the methanogenic microbial consortia set forth in b) above wherein the amount of solution employed facilitates dispersion of the nutrients from the aqueous solution into the foundation water;

f) optionally injecting a solution comprising inhibitors into the reservoir through the well head such that after injection the total concentration in the reservoir of inhibitors is above the critical concentration to effect inhibition of non-methane producing competing reactions but below a lethal dosing for the methanogenic microbes set forth in b) above wherein the amount of solution employed facilitates dispersion of the nutrients into the foundation water; and

g) maintaining said reservoir under conditions such that the rate of methanogenesis is increased.

As is apparent, a thorough analysis of the reservoir, while not necessary, allows for the evaluation of a sufficient number of factors affecting methanogenesis to be properly addressed by e.g., adjusting the amount and type of nutrients, etc., and then injecting such nutrients into the reservoir under appropriate conditions, enhanced methanogenesis at commercially viable rates can be achieved.

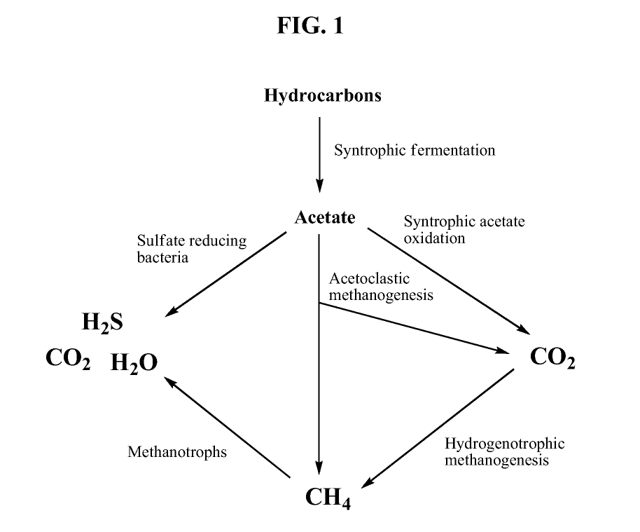

Referring to FIG. 1, methanogenic petroleum biodegradation in oil reservoirs proceeds primarily through syntrophic fermentation. Such biodegradation first leads to acetate and hydrogen as intermediates that are then utilized by various microorganisms for further biodegradation to methane. Microbes involved in the acetoclastic methanogenesis pathway convert acetate directly to methane (CH₄) and carbon dioxide (CO₂). Microbes in the syntrophic acetate oxidation pathway proceed to biodegrade acetate to carbon dioxide and hydrogen. The carbon dioxide is then reduced by microbes in the hydrogenotrophic methanogenesis pathway to methane. These microbes may co-exist with those that are adverse to methanogenesis such as sulfate reducing bacteria that metabolize acetate and hydrogen producing hydrogen sulfide (H₂S) water and CO₂ and methanotrophs that convert methane to various compounds including water and CO₂. The latter two are examples of “non-methane producing competing reactions” described above.

The present invention relates to methods for promoting microbial growth and activity that result in a substantial enhancement in the rate of production of methane (CH₄) in a subsurface oil reservoir.

In one preferred embodiment, such enhancement can be effected by identifying the petroleum components of a reservoir and determining that they are suitable for methanogenesis, selection of nutrients shown to be effective for the particular microbial consortia in the oil reservoir and then enhancing and preferably maximizing the total amount of nutrients available to the microbes such that methane generation is maximized while at the same time employing a concentration of nutrients in the well that is non-lethal to the microbes.

A major factor in activating adequate subsurface organisms to produce methane over a large volume of subsurface reservoir is to deliver nutrient solutions, at a critical nutrient concentration (ConcA) to activate the microorganisms at a commercial rate, to as large a volume of reservoir as possible. The objective then becomes injecting the minimum volume of water containing nutrients at the maximum safe concentration to avoid deactivating any key organisms (ConcH). At high nutrient concentrations below the critical concentration (ConcH), diffusive transport of nutrients into the formation away from high concentrations of injected advected solutions is at a maximum driven by the large concentration gradients and means that maximum reservoir can be accessed with minimal injected water volumes and raise the largest volume of water to ConcA from the smallest volume of injected water with a nutrient concentration at injection of below ConcH. Fluid concentration injected into the well will therefore be between ConcA and ConcH but ideally at a computed concentration dependent on the known diffusivity of the reservoir medium.

As a starting point in such a preferred embodiment, a determination is made of the petroleum components and the endogenous microbes present in the reservoir. Such factors are critical as each reservoir or oil field contains a unique mixture of petroleum components and microbes. Accordingly, the type of petroleum components and microbes present will dictate the nutrients and/or inhibitors which are to be used for that reservoir. Assays for determining the microbes present are known in the art including laboratory incubations of reservoir samples, culturing and culture independent analysis. Likewise, the mixture of hydrocarbons in the reservoir can be determined by conventional analytical means. In one embodiment, a single sample of hydrocarbons is used to determine the hydrocarbons present. In another, multiple samples are used to provide for a higher degree of certainty regarding the hydrocarbon components.

Nutrients and/or inhibitors for the microbes again can be determined based on the microbe type or by laboratory incubations under different conditions.

The selection of the appropriate nutrient(s) and/or inhibitor(s) as well as the total injected amount, rates of injection and injection points is then based on the size of the reservoir, the reservoir properties such as permeability and porosity and the amount and type of petroleum components present as well as the endogenous microbes and the presence of any non-nutrients. As to the size of the reservoir, determination of the field size, the water present, the concentration of nutrients and non-nutrients (e.g., salinity) already in the reservoir are well within the skill of the art.

The amount of nutrient (and/or inhibitors) added (injected) into the reservoir is conducted in an iterative process wherein a first injection of nutrients is conducted and after diffusion and equilibration, the concentration of nutrients is determined. Second and subsequent injections, if necessary, can be included until the desired concentration of nutrients is reached.

Optionally, the reservoir can be tested after injection and preferably after equilibration to confirm the concentration of each nutrient and/or inhibitor. Additionally, the reservoir can be retested periodically during methanogenesis to determine if additional nutrient and/inhibitor should be added.

In one embodiment, each of the injections is made through a well head or a plurality of well heads. Such well heads are conventional well heads having access to the subsurface reservoir. If recovery of methane is desired, then the well head(s) for injection can be the same well head(s) for such recovery. Alternatively, the well head(s) can be used to measure the increase in pressure within the reservoir which is reflective of the amount of methane production.

In another embodiment, the phosphate ion concentrations for use in combination with the ammonium ions are chosen such that the molar ratio of nitrogen to phosphorus is approximately 4:1. Higher concentrations of phosphorus may be employed including nitrogen to phosphorus ratios of 3.5:1, 3:1, and 2.5:1. The appropriate phosphorus concentration relative to the nitrogen concentration may be dependent on the particular phosphate reagent that is used and on the nature of the subsurface reservoir. In general the type and amount of phosphate chosen will minimize any precipitation of solids that is typically seen at higher phosphate concentrations.

In one embodiment, the nitrogen is provided by NH₄Cl. Other sources of nitrogen include ammonium phosphate.

In one embodiment, the phosphate ion is provided by KH₂PO₄. Other sources of phosphate ions for use in the present methods include NaH₂PO₄, either in anhydrous or hydrous form. The phosphate ion (KH₂PO₄⁻) is preferably added in an amount of from 0.2 to about 1.376 g/L.

In one preferred embodiment, the injected stimulants comprise ammonium, phosphate, nickel, and cobalt ions. It is understood, of course, that type and amount of the injected stimulants will be based on the presence and amount of stimulants already present in the reservoir.

In still other embodiments, one or more buffers are injected into the reservoir. Suitable buffers include carbonates (such as sodium carbonate, sodium bicarbonate, potassium carbonate, potassium bicarbonate) and alkali and alkaline earth hydroxides (such as LiOH, NaOH, KOH, Cs₂OH, Mg(OH)₂, and Ca(OH)₂). In one aspect, the buffer is NaHCO₃. The amount of buffer to be added is dependent on the salinity and pH of the reservoir, which can vary from reservoir to reservoir.

In still other embodiments, one or more complexing agents are injected into the reservoir. Such agents include nitrilotriacetic acid. The complexing agents can be used to bind to the stimulants to prevent precipitation and aid in stabilizing the stimulant mixture, can act as inhibitors by binding to metals detrimental to methanogenesis, or act as a source of carbon or nitrogen for microbes to further facilitate biodegradation of oil and methanogenesis, or act as complexing agents to accelerate natural uptake of key nutrient elements from the host reservoir rock.

In yet other embodiments, one or more inhibitors that minimize microbial activity that slow or are detrimental to methanogenesis may be used Inhibitors include those that inhibit the activity of iron-reducing, nitrate-reducing, or sulphate-reducing bacteria. Specific inhibitors include sodium molybdate (Na₂MoO₄) and hydrates of sodium molybdate for inhibiting sulfate reducers, and sodium chlorate (NaClO₃) for inhibiting nitrate reducers. Concentrations of sodium molybdate and sodium chlorate of about 20 mM are contemplated as suitable for use in this invention.

The stimulants (ammonium and phosphate ions, minerals, etc) inhibitors, buffers, and other agents may be combined together in one or more aqueous formulations. In one aspect, the ammonium and phosphate ions are contained in a single formulation. Salts such as NaCl and CaCl₂ may also be included in the formulations. The formulations may also be sparged with N₂ that will remove oxygen. In some aspects the water used in the formulations is the natural foundation water from the reservoir. In one embodiment, there is provided an aqueous solution of saturated ammonium and phosphate ions, optionally having a salinity between 0.1 to 1. In one preferred embodiment, the aqueous solution is foundation water, wherein the foundation water contains NaCL or CaCl2.

In one embodiment, the total salinity of the injected solutions being added to the reservoir will have a salinity similar to that of the reservoir. The salinity of the solutions may be adjusted by modifying the amount of added salts such as NaCl and CaCl₂ or other major ions present in the foundation water naturally.

Without being bound by theory, the formulation is believed to promote growth of microbes in the syntrophic fermentation, acetoclastic methanogenesis, syntrophic acetate oxidation, and hydrogenotrophic pathways shown in FIG. 1. Microbes involved in methanogenic hydrocarbon degradation include methanogens from the Methanomicrobiales (Methanocalculus spp., Methanogenium spp., Methanoculleus spp.), Methanosarcinales and anaerobic hydrocarbon fermenting bacteria such as Smithella spp., Syntrophus spp., Syntrophobacter spp., Syntrophomonas spp., and Marinobacter spp.

In one embodiment of the methods, an optional step of identifying reservoirs having one or more of above features are provided.

Such an optional analysis of the reservoir's environment can provide information that can be used to determine suitable microbial growth stimulants or in situ environmental conditions for microbial activity. The analysis can include determining the reservoir's temperature and pressure, which can be obtained in any suitable manner. While many reservoirs contain biodegraded oils, not all reservoirs contain currently active microbial populations. In one implementation, the analysis is to identify a zone in a reservoir that includes relevant active organisms biodegrading reactive petroleum components that can be accelerated to recover economic levels of methane through petroleum biodegradation.

To determine the environment in the reservoir, a geochemical analysis can be made of one or more fluids of the reservoir, such as foundation water and petroleum, and/or one or more solids of the reservoir, which analyses are familiar to those skilled in the art. The fluid analysis can include measurement of the state values (e.g., temperature and pressure) as well as a geochemical analysis of the foundation water, which can include assays for major anions and cations, pH, oxidation potential (Eh), chloride, bicarbonate, sulphate, phosphate, nitrate, ammonium ion, salinity, selenium, molybdenum, cobalt, copper, nickel, and other trace metals contents. The geochemical analysis can identify products that are known to be produced by indigenous microbial activity. For example, the presence of methane, CO₂, RNA, DNA, and/or specific carboxylic acids can be indicative of microbial activity. Methane relatively depleted in the carbon 13 isotope is frequently found in oilfields where natural methanogenesis has occurred. In particular, anaerobic hydrocarbon degradation metabolites, such as alkyl and aryl substituted succinates or reduced naphthoic acids, are markers of systems in which the anaerobic degradation of hydrocarbons is taking place. The identification of such markers can be used in determining the presence of active anaerobic petroleum degrading microbial consortia. See, for example, International Patent Application PCT/CA2009/001069 which is incorporated herein by reference in its entirety.

Injection of methanogenic nutrients into the foundation water of a petroleum reservoir can be accomplished using a variety of methods. The nutrients may be injected from a vertical injection well or a horizontal injection well. A horizontal injection well can be beneficial for the commercial scaling of the process as a larger area of the methanogen active formation oil/water zone can be accessed with the nutrient containing water injected for a single injection well. The commercial impact of the process can also be increased by injecting the nutrients using hydraulic fracturing which can increase the distance penetrated by the nutrient at quantities sufficient to provoke the desired rate of accelerated methanogenesis.

Injecting fluid through a well head into the zone of maximum microbial populations can include injecting fluid into the zone through a first set of one or more well heads, and producing gas from the zone can include producing gas from the zone through a second set of one or more wells. Injecting fluid into the zone can be concurrent with producing gas from the zone or can cease while producing gas from the zone. Injecting fluid into the zone can include injecting fluid into the zone through a first set of one or more wells and producing gas from the zone can include producing gas from the zone through a second set of one or more wells. A soak cycle can be allowed to endure in a region of the zone situated beneath a third set of one or more wells, while injection and production occur from the first and second set of one or more wells. During a later cycle, the first set of one or more wells can be allowed to endure a soak cycle, fluid can be injected into the zone through the second set of one or more wells and gas can be produced from the zone from the third set of one or more wells.

While generating methane gas in situ, production parameters can be monitored including the pressure in the reservoir and composition of the generated gas. Based on the monitored production parameters, injection into and/or production from the zone are controlled to enhance generation of biogenerated methane within the zone.

Implementations of the invention can include one or more of the following features. Controlling injection into and/or production from the zone to enhance generation of biogenerated methane from the zone can include controlling one or more of the following: an injector well flow rate; a composition of the one or more injectants injected into the reservoir; a quantity of the one or more injectants injected into the reservoir; a composition of the gas injected into the reservoir; a quantity of the gas injected into the reservoir; or a duration of injection, soak and production cycles for the reservoir.

Before producing hydrocarbons from the zone, an increase in reservoir pressure in the zone in response to an increase in biogenerated methane and the injected fluid can be monitored. Based on the reservoir pressure, the zone's gas saturation can be determined Production of hydrocarbons (oil, methane, and the like) from the zone can be commenced when the zone's gas saturation reaches a threshold gas saturation.

The injectants can be added to the reservoir together or in separate injection steps. For example, a slug or bank of water carrying one injectant can be followed by a second slug or bank of water carrying a second injectant. Another example may include alternately injecting one water bank followed by a gas injection step. In some implementations, injectants operating as stimulants may be injected at one location to enhance methanogenesis, and injectants operating as inhibitors may be injected at a different location, to prevent or minimize detrimental processes, such as methane oxidation. Injection of gas below a degrading oil column may facilitate circulation of water and nutrients to the microorganisms present.

In some implementations, layered reservoir bioreactors can be used for methane production and to facilitate methane removal. In such a reservoir bioreactor, the biodegrading oil column and/or residual oil zones are vertically segmented and the environment can be controlled, for example, in the following manner: (a) a lower zone of degradation of oil or injected reactive organic substrates can be environmentally modified to produce abundant free gas (e.g., methane and/or carbon dioxide); (b) an upper zone of degradation of oil or injected reactive organic substrates is environmentally modified to produce abundant free methane; and (c) free gas from the lower layer buoyantly moves up through the layered bioreactor and any free methane or methane in aqueous or oil solution partitions into the moving gas phase and is carried to a gas-rich zone for production.

Microorganisms in subterranean reservoirs tend to be most active at environmental boundaries where they have access to water and the requisite hydrocarbons for biodegradation, such as between fermentation zones and methanogenesis zones. Therefore, microorganism activity in a reservoir may be increased by increasing the area where these conditions prevail. One method for increasing the area with suitable conditions is to modify the water flood injection rates. Yet another method involves forming small-scale environmental interfaces by forming petroleum-water emulsions in the reservoir, or by changing the clay chemistry.

Preferably, increases in methanogenesis of at least 10⁴, 10⁵, 10⁶ or higher over endogenous methane production can be achieved. For the sake of completeness, endogenous methane production refers to the amount of methane produced over a given period of time without any intervention in the reservoir which is low being typically on the order of 10⁻⁴ kg/m² of oil water contact area/year.

Further descriptions of methods and systems for gas production from a reservoir are set forth in Canadian Patent Application No. 3,638,451 which is incorporated herein by reference in its entirety.

The following examples are provided to further illustrate certain aspects of the present invention and to aid those of skill in the art in practicing the invention. These examples are not meant to limit the scope of the invention.

### EXAMPLES

The following three solutions were prepared and used in the methods of the invention.

### Example 1

A 1 L aqueous solution of nutrients for reservoir injection was prepared using the following compounds:

| Nutrient | g/liter H₂O |
|---|---|
| MgCl₂ | 0.363543 |
| NH₄Cl | 0.066819 |
| KH₂PO₄ | 0.016991 |
| NaHCO₃ | 0.800235 |
| FeSO₄ | 0.001012 |
| H₃BO₄ | 2.65 × 10⁻⁵ |
| MnCl₂ | 5.61 × 10⁻⁵ |
| CoCl₂ | 0.000914 |
| NiCl₂ | 0.000115 |
| CuCl₂ | 1.39 × 10⁻⁶ |
| ZnSO₄ | 7.13 × 10⁻⁵ |
| Na₂MoO₄ | 1.97 × 10⁻⁵ |
| Na₂SeO₃ | 4.38 × 10⁻⁶ |
| Na₂WO₄ | 6.28 × 10⁻⁵ |
| NaCl | 7 |
| CaCl₂ | 0.12 |
| NaH₂PO₄ | 0.175 |

### Example 2

The following solution is prepared with reservoir water from a Western Canadian sandstone heavy oil reservoir:

| Nutrient | Per liter H₂O | |
|---|---|---|
| NH₄Cl | 5.4 | g |
| KH₂PO₄ | 1.376 | g |
| Selenite-tungstate Solution | 1 | mL |
| Trace Element Solution | 1 | mL |

Optionally, 2.5 mM Na₂S can be added as a reducing agent/oxygen scavenger if the solution is stored over a prolonged period of time.

The Selenite-tungstate Solution is prepared as a 1 liter aqueous solution using the following compounds:

| Nutrient | per liter H₂O |
|---|---|
| NaOH | 400 mg |
| Na₂SeO₃ × 5H₂O | 6 mg |
| Na₂WO₄ × 2H₂O | 8 mg |

The Trace Element Solution is prepared as a 1 liter aqueous solution containing the following compounds:

| Nutrient | per liter H₂O | |
|---|---|---|
| HCl (25% = 7.7M) | 12.5 | ml |
| FeSO₄ × 7H₂O | 2100 | mg |
| H₃BO₄ | 30 | mg |
| MnCl₂ × 4H₂O | 100 | mg |
| CoCl₂ × 6H₂O | 190 | mg |
| NiCl₂ × 6H₂O | 24 | mg |
| CuCl₂ × 2H₂O | 2 | mg |
| ZnSO₄ × 7H₂O | 144 | mg |
| Na₂MoO₄ × 7H₂O | 36 | mg |

The nutrients are added to a mixture of foundation water and heavy oil such that the final concentration of the ammonium ions is 5.4 g/L and the final concentration of the phosphate ions is 1.376 g/L. the mixture is incubated under conditions in which methanogenesis is significantly enhanced.

All publications and patent applications mentioned in this specification are herein incorporated by reference to the same extent as if each individual publication or patent application was specifically and individually indicated to be incorporated by reference.

Modifications to the invention will be apparent to one of skill in the art given this disclosure. Such modifications and the resulting equivalents to the embodiments and examples described above are intended to be included within the scope of the following claims.

1. A method for increasing the rate of methanogenesis in a petroleum reservoir comprising methanogenic microbial consortia and foundation water which method comprises:
a) injecting through a well head a bolus of a solution of stimulants comprising ammonium ions and phosphate ions into the reservoir in an amount such that their concentration in at least a portion of the reservoir is above a critical concentration to effect enhanced methanogenesis but at a non-lethal level to the methanogenic microbial consortia; and
b) maintaining said reservoir under conditions such that the rate of methanogenesis is increased,
wherein the concentration of the ammonium ions injected through the well head is up to about saturation concentration and the concentration of phosphate ions injected through the well head is up to about saturation concentration, and further wherein the concentration of stimulants in the solution facilitates dispersion of the stimulants from the solution into the foundation water, and still further wherein the composition of the foundation water is not significantly altered but for the stimulants added.

2. The method of claim 1, wherein the amount of the solution of stimulants added to the reservoir is such that the salinity of the reservoir does not change by more than 1%.

3. The method of claim 2, wherein the amount of the solution of stimulants added to the reservoir is such that the salinity of the reservoir does not change by more than 0.1%.

4. The method of claim 1, wherein the temperature of the solution of stimulants is maintained at approximately the temperature of the foundation water in the reservoir to which it is being added.

5. The method of claim 1, wherein the solution of stimulants comprises from about 1 g/L to about saturation concentration of ammonium ions and from about 0.4 g/L to about saturation concentration of phosphate ions.

6. The method of claim 1, wherein the solution is an aqueous solution.

7. The method of claim 1, wherein a second solution is injected into the reservoir through the well head which comprises an inhibitor or a mixture of inhibitors wherein the amount of the inhibitors in the second solution is sufficient to maintain a rate of methanogenesis in said reservoir in conjunction with the added nutrients and wherein the amount of inhibitors added to said reservoir water is non-lethal to said microbes.
